(19) United States
(12) Patent Application Publication
(10) Pub. No.: US 2002/0006458 A1
(43) Pub. Date: Jan. 17, 2002

(54) Method of making colored sugar product having a gem-like appearance and product made in accordance with same

(76) Inventor: Thanad Berkna, Bangkok (TH)

Correspondence Address: STITES & HARBISON, PLLC, 400 W MARKET ST, SUITE 1800, LOUISVILLE, KY, 40202-3352, US

(21) Appl. No.: 09/885,142

(22) Filed: Jun. 20, 2001

Related U.S. Application Data
(60) Provisional application No. 60/212,971, filed on Jun. 21, 2000.

(51) Int. Cl. C13F 3/00

(52) U.S. Cl. 426/302; 127/63; 426/103

(57) ABSTRACT

A process for making a colored crystalline sugar product comprises sizing sugar crystals, randomly tumbling the crystals beneath a spray of liquefied extract having color giving attributes so as to essentially and uniformly coat the entire surface area of each crystal, and then slowly drying the crystals at a temperature slightly above room temperature for a predetermined time interval, thus providing the finished product with a gemstone-like appearance.

This application claims priority from Provisional Patent Application No. 60/212,971 filed Jun. 21, 2000.

### BACKGROUND OF THE INVENTION

The present invention relates to sugar products that are provided coloring and flavoring and more particularly to sugar products that are colored and flavored through the addition of natural ingredients such as certain herbal extracts.

Rock sugars are readily available, naturally occurring products and in their natural state are either colorless or white. Such sugars are consumed either independently as treat or employed as sweetening additives to other food or beverage products. In many instances, however, it is desirable that the sugars be given a color distinguishing the sugar from the natural occurring white or colorless appearance. To do this, various synthetic coloring materials have been used. However, there is a growing emphasis on natural foods with the pronounced view that foodstuffs having synthetic additives are not healthy. This view against the consumption of foodstuffs incorporating synthetic ingredients is exacerbated in those countries requiring the ingredients and additives to be listed on the container. To address this shift toward the use of natural ingredients, many manufacturers have attempted to use naturally occurring materials as additives. Sugar manufacturers, for example, have resorted to using vegetable-based extracts to color sugars. A problem with such natural additives to sugars is that the color provided by such naturally occurring additives tends to fade very quickly unless chemical stabilizers are used.

It is therefore a paramount object of the present invention to provide for a sugar product that uses naturally occurring materials to provide for a desired color to the sugar product.

It is yet another important object of the present invention to provide for sugars with coloring without adding synthetic materials to stabilize the color.

It is still another important object of the present invention is to provide for a sugar product with a desired color that is resistant to fading.

Still a further important object of the present invention is to provide a sugar product with a desired color to permit the sugar to resemble a colored gem-like stone appearance with a concomitant resistance to fading.

### SUMMARY OF THE INVENTION

The present invention involves the initial step of obtaining a supply of sugar crystal and then crushing the crystals into smaller pieces and then sifting or selecting crystals of certain sizes for further processing. The selected crystals are then formed into a thin layer and caused to randomly move about for a set time period. During this time period the crystals are coated with a selected herbal extract having coloring attributes, i.e. the ability supply color to the crystal surface, preferably by being sprayed so as to coat the substantially the entire surface of each crystal. Following coating, the crystals are moved to a drying station where the crystals are dried at a temperature slightly above room temperature for a second set time period. Thereafter, various batches of crystals made in this manner varying the amount of extract applied from batch to batch are preferably mixed in certain predetermined ratios thus resembling naturally occurring gems which have a distribution of shades and hues within a family of color.

### DESCRIPTION OF THE DRAWING

FIG. 1 is a flow chart representing a series of steps when practicing the method of the present invention.

FIG. 2 is a schematic of an apparatus that may be used to practice the method of the present invention.

### DETAILED DESCRIPTION OF THE PREFERRED EMBODIMENT

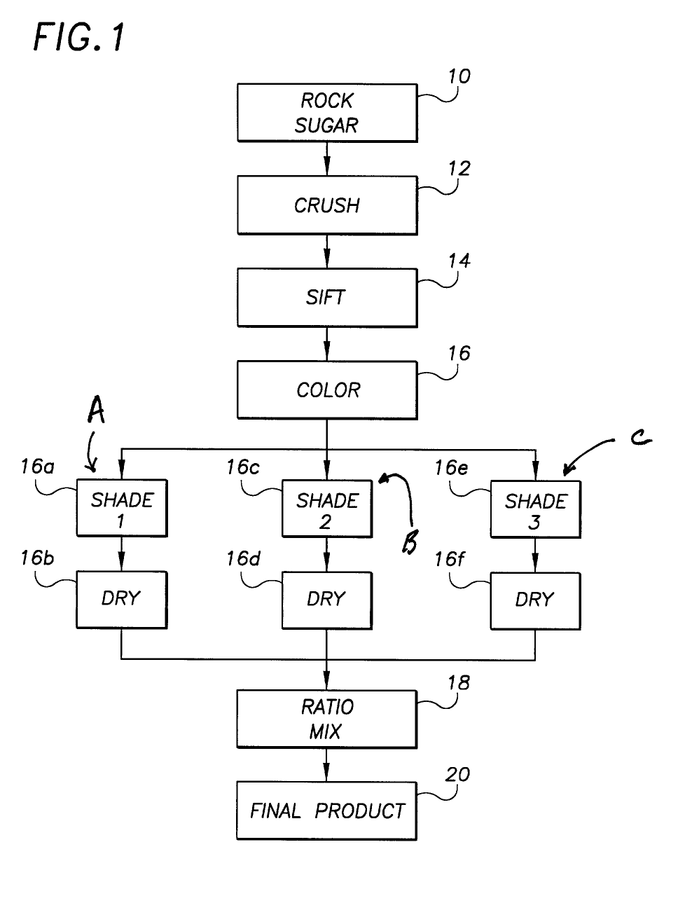

Referring to the flow chart of FIG. 1, the initial step shown by block 10 involves starting with large size rock or refined sugar crystals and comminuting the crystals into smaller more manageable crystals by any of several well known grinding or crushing techniques depicted by block 12 into appropriate range for sizing. Thereafter, the sugar crystals can be sized or sifted as step 14 into the desired size range, preferably between about 0.1 mm to 50 mm through various known sieving methods such as, for example, through the use of a vibrated perforated bed or screens. For example, a plurality of vibrating screens of different mesh sizes can be used in a tiered tandem relationship to obtain a batch of crystals of very similar sizes. Once the crystals have been selected with the desired size range, they are now ready to be colored as indicated by block 16. It is important that the crystals be coated over their entire surface with color imparting liquids, preferably with an herbal extract solution such as butterfly pea flower, roselle, mulberry tea, and combinations thereof (known as “rainbow ” extract) in such a manner to preclude any dissolution of the sugar into solution. Coating over the entire surface is also important to maintain the gem-like appearance that is preferred by the consumer and, collectively with the drying step discussed below, to minimize fading. The particular type of herbal extract that is selected depends upon the family of color that is desired for the final sugar product. The distribution of the liquefied extract is best accomplished by spraying or misting the surfaces with a thin layer of extract while the crystals are being randomly tumbled about so as to expose the entire surface area of each crystal to the extract during a predetermined time period. A preferred technique is tumble the crystals in vibrating tumbler or conveyor while being exposed to the spray or mist. Such tumbling during exposure promotes a uniform but thin coating of extract over the entire surfaces of the crystals. The precise timing of the coating step depends upon the extract being employed and the intensity of the color to be imparted to the crystal. For example, it has been found that 300 kilograms of crystalline sugar may be coated with 3 liters of the herbal extract over a period of between 3 to 30 minutes until the desired color is obtained.

Following coating, the crystals must be slowly dried at temperatures slightly above room temperature. It is found that this slow drying step is important as in concert with the careful coating of the surfaces of the crystals it helps minimize the fading of the color imparted to the crystals. For example, it is preferred that the crystals be dried at temperatures between about 30° C. to 60° C. over a period of 1 to 15 hours, preferably between about 2 to 6 hours. The prolonged drying assists in minimizing the fading of the coloring. When it is desired to intensify the coloring of any particular batch of crystals, the crystals may be recoated any multiple number of times, but it is preferred and recommended that the crystals be completely dried and cooled before additional coatings are applied. The resulting sugar product has a gemstone-lie appearance as the surface coating supplies a coloring to an essentially translucent or transparent crystal as is perceived with gem stones.

To further minimize the perception of fading and to promote an even more total gem-like appearance, advantage can be taken from the differentiation in coloring obtained between batches of crystals that have been produced from the steps taken above. It has been found that by mixing the batches of crystals of the same coloring family but with different shades or hue that the gem-like appearance can be enhanced even further. Natural occurring gem stones vary in hue and shade. Thus, the mixing provides an aggregate total appearance more like the such gem stones. Alternatively, certain of batches could go through recoating and then mixed with the others. The flow chart of FIG. 1 illustrates this series of sub-steps as 16a, 16b for a first batch, sub-steps 16c, 16d for a second batch, and sub-steps 16e, 16d for a third batch. Each batch may, for example, have different volume levels of extract applied to the surfaces of the crystals with drying times corresponding to that necessary to dry the crystals in each batch. The batches then may be blended in a ratio that would provide the preferred natural gem-like appearance as depicted in step 18. For example, the three batches could be blended in ratios such as 1A:1B:1C; 2A:1B:1C; 1A:2B:1C; or any other reasonable combination to allow multiple shades or hues to be visible within the mixture, and thus to promote the natural gemstone appearance of the final product as noted by block 20. Although fading is minimize by the observation of the steps discussed above, it will be appreciated that because mixing that provides a gemstone appearance, the perception of any fading is further minimized due to the presence of the multiple shades and hues.

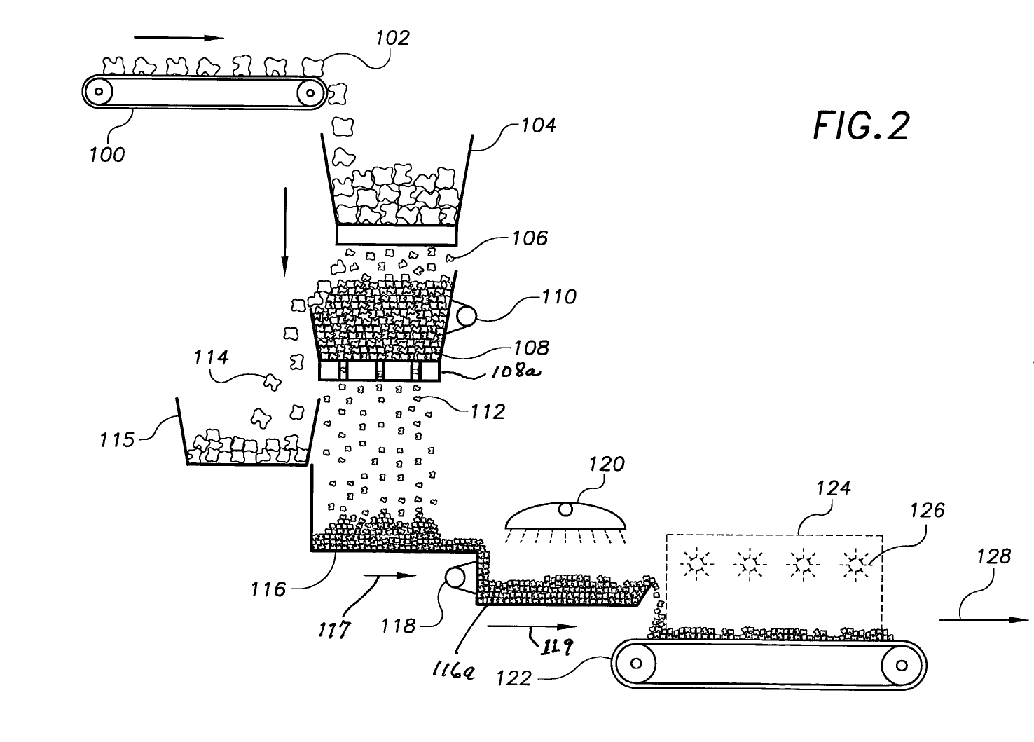

Various apparatus may be used to practice the invention as long as the steps of the method are followed. FIG. 2 schematically illustrates an assembly of various apparatus that may used comprising generally conveying, sorting, tumbling, and oven components. A conveyor 100 may be loaded with a desired quantity of rock crystals 102 and moved toward and emptied into a crusher device 104. The crystals are then ground into small particles 106 appropriate for further processing and sizing. The particles are then fed into a multiple screen vibratory device 108 powered by a conventional vibratory motor 110 where the particles 114 above a certain predetermined size, preferably between about 0.5 mm to about 50 mm, are moved into a storage container 115 while the particles 112 at or below the predetermined size move or fall through the mesh of the vibrating screen 108a and are deposited on the bed of a vibratory conveyor 116 and are slowly moved as indicated by arrow 117a to a vibratory tumbling section 116a powered by motor 118 as a thin layer of crystals. In the tumbling section 16a, the layer of crystals are essentially fluidized and move randomly about under the spray head 120 that is connected to a remote source of liquefied extract (not shown). A spray or mist of extract is distributed from the spray head 120 evenly over the surfaces of crystals without causing dissolution of the crystalline material into solution thereby providing the color or tint to the W crystal material. Once a predetermined volume of extract has been delivered over the appropriate time period, the crystals are then moved either by vibratory action as depicted by arrow 119 or otherwise delivered to still another conveyor 122 that places the crystals in a drying oven (depicted by dashed lines 124). The crystals are held in the oven beneath drying elements 126 for a period of time required to thoroughly dry the imparted coatings. Following drying, the crystals are relocated as indicated by arrow 128 to a storage area (not shown) for cooling and further processing. As mentioned above, it may be desirable that the crystals of a selected batch be recoated and this can be accomplished by delivering the selected batch to the front part of vibratory conveyor 116 for another spraying application and subsequent drying. Further This may be repeated several times until the desired coloring for the selected batch is reached.

It should be understood that, in the light of the foregoing description, those with ordinary skill in the art will be able to make changes and modifications to the present invention without departing from the spirit or scope of the invention as defined herein and as claimed.

1. A process for producing a batch of sugar crystals having a color added thereto causing the crystal to have a gem-like appearance comprising the steps of
(a) randomly tumbling sugar crystals of a predetermined size;
(b) applying a coating of a liquefied extract having color attributes to said randomly tumbling sugar crystals so as to coat substantially the entire surface of each of said crystals;
(c) and drying said coated crystals for a predetermined time period at a temperature above room temperature.

2. The process of claim 1 in which said step of applying the coating is done for a predetermined time interval of between about 3 to 30 minutes.

3. The process of claim 1 in which said liquefied extract is selected from a group of herbal extracts consisting of butterfly pea flower, safflower, roselle, mulberry tea, and a mixture of two or more thereof

4. The process of claim 1 in which said predetermined time period is between about 1 hour and 15 hours.

5. The process of claim 1 in which at least one additional batch of sugar crystals is produced in accordance with steps (a)-(c) where the time interval for delivery of said liquefied extract is different and said first and second batches are mixed in accordance with a predetermined ratio to provide a mixed sugar crystal product having various shades of coloring.

6. A crystalline sugar product made in accordance with the method of claim 1.

7. The process of claim 1 in which the predetermined size is between about 0.5 to 50.0 mm.

8. A process for making a first batch of sugar product having a gem-like appearance comprising the steps of
(a) obtaining a supply of sugar crystals;
(b) crushing the crystals into smaller crystals having a predetermined range of sizes;
(c) selecting crystals of a certain size from said predetermined range of sizes;
(d) forming a layer of crystals and randomly tumbling the selected crystals for a predetermined time period;
(e) distributing a predetermined amount of liquefied herbal extract over the crystals while being randomly tumbled thereby uniformly coating with said extract and providing a color to the surface of the selected crystals; and
(f) drying the selected and uniformly coated crystals at a temperature slightly above normal room temperature thereby providing a finished sugar product having a gem-like appearance.

9. The method of claim 8 including making a second batch of sugar products in accordance with steps (a)-(f) and mixing said first and second batches of sugar products to form a mixture having the appearance of gem-like crystals with a plurality of hues.

10. The method of claim 9 in which said second batch has a different predetermined amount of extract distributed thereover.

11. The method of claim 9 including the making of multiplicity of batches of sugar products through steps (a)-(f) and mixing the multiplicity of batches together in a predetermined ratio.

12. The method of claim 8 in which said step of distributing the extract is accomplished by spraying the extract over the layer of crystals being randomly tumbled.

13. The method of claim 8 in which said step of distributing extract is accomplished by providing a mist of extract over the layer of crystals being randomly tumbled.

14. The method of claim 8 wherein said liquefied herbal extract is selected from a group of herbal extracts consisting of butterfly pea flower, safflower, roselle, mulberry tea, and a mixture of two or more thereof.

15. The method of claim 8 in which the step of drying said coated and selected crystals is done at temperatures between about 30° C. and 60° C.

16. The method of claim 15 in which the step of drying is done for a time period of between about 1 to 15 hours.

17. The method of claim 15 in which the step of drying is done for a period of between about 2 to 6 hours.

18. The method of claim 8 in which the selected crystals are randomly tumbled by a vibratory apparatus.

19. The method of claim 8 in which the finished sugar product is treated again in accordance with steps (d)-(f) to recoat the surfaces of the product with at least one additional coating of extract.
